(19) United States
(12) Patent Application Publication
(10) Pub. No.: US 2022/0000137 A1
(43) Pub. Date: Jan. 6, 2022

(54) METHOD FOR PRODUCING ALMOND-FLAVORED OIL AND FAT

(71) Applicant: FUJI OIL HOLDINGS INC., Osaka (JP)

(72) Inventors: Yuta SUZUKI, Ibaraki (JP); Tomoaki KUMATANI, Ibaraki (JP); Takuma UETSUKI, Ibaraki (JP)

(73) Assignee: FUJI OIL HOLDINGS INC., Osaka (JP)

(21) Appl. No.: 17/289,720

(22) PCT Filed: Aug. 22, 2019
(86) PCT No.: PCT/JP2019/032795

§ 371 Date: Apr. 28, 2021

(51) Int. Cl. A23D 9/04; A23D 9/007; A23G 3/40

(52) U.S. Cl. CPC A23D 9/04; A23G 3/40; A23D 9/007

(57) ABSTRACT

The present invention addresses the problem of providing a method for producing an almond-flavored oil and fat with which it is possible to reduce an amount of almond flour used in making confectionery. It was found that an oil and fat having a good roasted almond flavor can be obtained by a production method including heating an oil and fat in the presence of 0.6 to 20% by mass of an almond-derived raw material with respect to the oil. In particular, a stronger and better flavor could be obtained by using blanched almond flour and heating a reaction system purged with an inert gas.

### TECHNICAL FIELD

The present invention relates to a method for producing an oil and fat having a good roasted almond flavor, and a food product formed using the flavored oil.

### BACKGROUND ART

Patent Literature 1 discloses a method for producing a flavored oil and fat. It discloses a method of adding rice bran to an oil and fat and heating them.

### REFERENCE LIST

### Patent Literature

Patent Literature 1: Japanese Patent Laid-Open No. H1-218549

### SUMMARY

### Technical Problem

In western-style confectioneries such as madeleines, financiers, and macaroons, relatively expensive raw materials such as butter and ground almonds are used as raw materials to realize a gorgeous and rich flavor that is typical of western-style confectionery. However, these raw materials are expensive due to reasons such as small supply with increasing demand accompanying population growth around the world. In addition, a method of achieving use of alternative raw materials and reduction in amount used within a range not changing a flavor has been sought also from the viewpoint of sustainability. Accordingly, an objective of the present invention is to provide a method for producing a flavored oil and fat which can reduce an amount of ground almonds used when making western-style confectionery.

### Solution to Problem

The inventors of the present invention have diligently conducted examinations to achieve the above-described objective.

Patent Literature 1 was intended for a rice oil-derived oil and fat that is rich in the flavor, but a new flavor has been further required. The inventors of the present invention have further conducted examinations and found a production method by which an oil and fat having a good roasted almond flavor can be obtained through heating and reacting the oil and fat in the presence of an almond-derived raw material. Thereby, the present invention has been completed.

That is, the present invention relates to the following aspects.

(1) A method for producing a flavored oil and fat, the method including reacting an oil and fat at 80° C. to 210° C. for 0.2 to 4 hours in the presence of 0.6% to 20% by mass of an almond-derived raw material with respect to the oil and removing solid contents thereafter.

(2) The production method according to (1), in which the almond-derived raw material is ground almonds.

(3) The production method according to (1) or (2), in which the reaction is carried out in a depressurization state.

(4) The production method according to (1) or (2), in which the reaction is carried out in an inert gas atmosphere.

(5) The production method according to (4), in which a temperature is raised by heating in the inert gas atmosphere.

(6) A food product formed using a flavored oil and fat produced by the production method according to any one of (1) to (5).

(7) A western-style confectionery formed using a flavored oil and fat produced by the production method according to any one of (1) to (5).

### Advantageous Effects of Invention

According to the present invention, it is possible to provide an oil and fat having a good roasted almond flavor for use in western-style confectionery.

### DESCRIPTION OF THE EMBODIMENTS

The present invention relates to a method for producing an oil and fat having a good roasted almond flavor. In particular, the purpose is to produce a flavored oil and fat still having deliciousness and longer flavor persistence even with reduction in amount of ground almonds used in western-style confectionery. Western-style confectionery is a product having wheat flour, butter, and ground almonds as typical raw materials. More specifically, there are crème d'amandes, macaroons, dacquoises, and the like, in addition to madeleines and financiers. A most preferable western-style confectionery is a product, such as madeleines and financiers, which is obtained by preparing a dough by blending ground almonds in a dough mainly composed of wheat flour, and baking the dough. By using an oil and fat according to the present invention in such a product, effects of maintaining deliciousness and imparting longer flavor persistence while allowing reduction in amount of ground almonds used in western-style confectionery are exhibited. In the present invention, the expression “for use in western-style confectionery” is used, and the expression also includes confectioneries to be created in the future by easily imparting an almond flavor using the present oil and fat, in addition to existing confectionery for which recipes in which ground almonds are blended in have already been established in the past.

In the method for producing an oil and fat according to the present invention, various kinds of oil and fat can be used. Specific examples thereof include various animal and vegetable oils/fats such as soybean oil, cottonseed oil, corn oil, safflower oil, olive oil, palm oil, rapeseed oil, rice bran oil, sesame oil, kapok oil, palm oil, palm kernel oil, coconut oil, lard, fish oil, and whale oil, and hardened oils, fractionated oils, and transesterified oils thereof. It is obvious that an oil and fat in which two or more of these oils have been mixed can also be used.

A palm oil, a fractionated palm oil, and a rapeseed oil are more preferable, and it is possible to impart a good roasted almond flavor to an oil and fat by using, even more preferably, a palm oil or a fractionated palm oil.

In the method for producing an oil and fat according to the present invention, an almond-derived raw material is used for the purpose of flavoring an oil and fat. In the present invention, examples of almond-derived raw materials include almond paste, sliced almonds, crushed almonds, ground almonds, and the like, and one kind thereof may be used alone or they may be used in combination. Among them, ground almonds are most preferable, because they are finely crushed, and this improves contact efficiency with an oil and fat, making it easier to extract flavoring ingredients and making it easier to separate them by filtration. The ground almonds are powdered almonds and are sometimes called almond flour. They are roughly classified into blanched ground almonds, unblanched ground almonds, and roasted ground almonds. In particular, it is more preferable to use unblanched ground almonds, and it is possible to impart a good roasted almond flavor to an oil and fat by the method according to the present invention.

In the method for producing an oil and fat according to the present invention, it is required to perform heating in the presence of a total amount of 0.6% to 20% by mass of an almond-derived raw material. The phrase “0.6% by mass or more with respect to the oil” means that, for example, 0.6 kg or more of an almond-derived raw material is added into 100 kg of an oil and fat. An amount of the almond-derived raw material added into the oil and fat is more preferably 1% to 15% by mass, and by using, even more preferably, 1.5% to 13% by mass of the almond-derived raw material, it is possible to obtain a good roasted almond-flavored oil and fat.

Next, a process of the production method according to the present invention will be described.

In the method for producing an oil and fat according to the present invention, a defined amount of the almond-derived raw material is added, and heating is performed at 80° C. to 210° C. It is possible to obtain a good roasted almond-flavored oil and fat by heating preferably at 110° C. to 200° C., and more preferably at 130° C. to 185° C.

In the method for producing an oil and fat according to the present invention, a defined amount of the almond-derived raw material is added, and a reaction is caused at a defined temperature for 0.2 to 4 hours. It is possible to obtain a good roasted almond-flavored oil and fat by causing a reaction more preferably for 0.3 to 3 hours, and even more preferably for 0.5 to 2 hours.

In the method for producing an oil and fat according to the present invention, it is preferable that a defined amount of the almond-derived raw material be added, and a reaction be caused at a defined heating temperature for a defined time in a depressurization state in which a degree of vacuum in a reaction system is 60 mmHg or less. A depressurization condition is more preferably 55 mmHg or less and is even more preferably 50 mmHg or less. By reducing a pressure inside the reaction system, thermal degradation of an oil and fat can be suppressed.

Furthermore, in the method for producing an oil and fat according to the present invention, it is preferable to carry out the reaction in an inert gas atmosphere in which an oxygen concentration in the reaction system is 5.0% by volume or less. Furthermore, heating in an inert gas atmosphere to raise a temperature is also one aspect of the method for producing an oil and fat according to the present invention. An oxygen concentration in the reaction system is more preferably 1.0% by volume or less, and is even more preferably 0.5% by volume or less. Heating and stirring by this method is more preferable, because it allows volatile aroma components that contribute to the flavor to remain in an oil while suppressing thermal degradation of an oil and fat. As an inert gas for lowering an oxygen concentration in the reaction system, nitrogen, carbon dioxide, and the like can be exemplified.

In the present invention, a defined amount of the almond-derived raw material is added into a defined oil and fat. Thereafter, a reaction is caused at a defined heating temperature for a defined time while stirring. The reaction is carried out by starting time measurement from a time point at which an oil and fat temperature reaches a temperature set as a heating temperature, and maintaining the temperature within a range of a set temperature plus or minus 5° C. for a set time. It is desirable that a temperature be raised to the set temperature as quickly as possible, and it is not desirable to perform stepwise temperature change that intentionally changes a heating temperature and a time.

In the present invention, after a predetermined reaction, a solid content containing the added almond-derived raw material is removed. This removal can be performed by filtration through filter paper, but a filter press or a centrifuge machine can also be used in large-scale production. In this manner, an oil and fat having a desired roasted almond flavor can be prepared. Accordingly, the same flavor-imparting effect is expected for, for example, nuts other than almonds, and grains such as wheat, soybeans, corn, and other legumes.

Although it is speculation, it is thought that, in an oil and fat obtained by the method according to the present invention, ingredients, which are contained in heated almond-derived raw materials such as furfural, ethanone, 2-furanmethanol, 5-methyl-butyrolactone, and 2,5-dimethyl-4-hydroxy-3(2H)-furanone, are active ingredients that impart the flavor.

A flavored oil, which has an almond flavor, obtained by the present invention can be used as an oil and fat suitable for usage applications in various food products such as margarine, shortening, paste, cream, and western-style confectionery. In particular, when it is used for western-style confectionery, a preferred almond flavor can be obtained even with reduction in amount of ground almonds used.

### EXAMPLES

Hereinafter, examples of the present invention will be described to explain the present invention in more detail, but the spirit of the present invention is not limited to the following examples. In the examples, % and part mean a weight basis.

Examination 1 Preparation of Flavored Oil

TABLE 1
Formulation

| | | | | | | | | | | Comparative | |
|---|---|---|---|---|---|---|---|---|---|---|---|
| | Example | | | | | | | | | Example | |
| | 1 | 2 | 3 | 4 | 5 | 6 | 7 | 8 | 9 | 1 | 2 |
| Purified palm | 100 | 100 | 100 | 100 | 100 | 100 | 100 | 100 | 100 | 100 | 100 |
| oil | | | | | | | | | | | |
| Blanched | 8.0 | | | | 4.0 | 16.0 | 8.0 | 8.0 | 8.0 | 8.0 | 8.0 |
| ground almond | | | | | | | | | | | |
| Unblanched | | 8.0 | | | | | | | | | |
| ground almond | | | | | | | | | | | |
| Roasted | | | 8.0 | | | | | | | | |
| ground almond | | | | | | | | | | | |
| Sliced almond | | | | 8.0 | | | | | | | |
| Heating | 150 | 150 | 150 | 150 | 150 | 150 | 130 | 170 | 150 | 50 | 230 |
| temperature | | | | | | | | | | | |
| (° C.) | | | | | | | | | | | |
| Heating time | 1.0 | 1.0 | 1.0 | 1.0 | 1.0 | 1.0 | 1.0 | 1.0 | 1.0 | 6.0 | 0.5 |
| (h) | | | | | | | | | | | |

In a 1 L three-necked flask, 40 g of blanched ground almonds (“Blanched almond flour” sold by Tomizawa Shoten Co., Ltd.) were added into 500 g of a purified palm oil (manufactured by FUJI OIL CO., LTD.), and the mixture was reacted at 150° C. for 1 hour under a reduced pressure of 50 mmHg while being stirred (350 rpm). Thereafter, the mixture was cooled to 60° C., and an oil and fat and a solid content were separated by filtration with filter paper (No. 5C, Advantec Toyo Kaisha, Ltd.). Thereby, a roasted almond-flavored oil of Example 1 was obtained.

A roasted almond-flavored oil of Example 2 was obtained in the same manner as in Example 1 except that the blanched ground almonds were replaced by unblanched ground almonds (“Unblanched ground almonds” sold by Tomizawa Shoten Co., Ltd.).

A roasted almond-flavored oil of Example 3 was obtained in the same manner as in Example 1 except that the blanched ground almonds were replaced by roasted ground almonds (“Roasted almond flour” sold by Tomizawa Shoten Co., Ltd.).

A roasted almond-flavored oil of Example 4 was obtained in the same manner as in Example 1 except that the blanched ground almonds were replaced by sliced almonds (“Sliced raw almonds” sold by Tomizawa Shoten Co., Ltd.).

A roasted almond-flavored oil of Example 5 was obtained in the same manner as in Example 1 except that an amount of the blanched ground almonds added was changed from 8.0% to 4.0%.

A roasted almond-flavored oil of Example 6 was obtained in the same manner as in Example 1 except that an amount of the blanched ground almonds added was changed from 8.0% to 16.0%.

A roasted almond-flavored oil of Example 7 was obtained in the same manner as in Example 1 except that a heating temperature was changed from 150° C. to 130° C.

A roasted almond-flavored oil of Example 8 was obtained in the same manner as in Example 1 except that a heating temperature was changed from 150° C. to 170° C.

In the same manner as in Example 1 except that a reaction was carried out without reducing a pressure by filling a reaction system with nitrogen as an inert gas to reduce an oxygen concentration to 0.1% by volume or less, the following process was performed as follows. In a 1 L three-necked flask, 40 g of blanched ground almonds were added into 500 g of a purified palm oil, and the mixture was reacted at 150° C. for 1 hour while being stirred (350 rpm). Thereafter, the mixture was cooled to 60° C., and an oil and fat and a solid content were separated by filtration with filter paper. Thereby, a roasted almond-flavored oil of Example 9 was obtained.

A roasted almond-flavored oil of Comparative Example 1 was obtained in the same manner as in Example 1 except that a heating temperature was changed from 150° C. to 50° C., a reaction time was changed to 6 hours, and separation was performed by filtration after the reaction.

A roasted almond-flavored oil of Comparative Example 2 was obtained in the same manner as in Example 1 except that a heating temperature was changed from 150° C. to 230° C., and a reaction time was changed to 0.5 hours.

“Method of Evaluating Flavored Oil and Fat”

Regarding the flavored oils prepared with the formulations shown in Table 1, five panelists, who are engaged in the development of western-style confectionery materials and are conducting a sensory evaluation of a prototype western-style confectionery every day, performed a sensory evaluation on these samples by a consensus on scores of 1 to 5 while imagining a roasted almond flavor. As a result of the flavor evaluation, 3 or higher points were regarded as a pass.

The flavored oils (Examples 1 to 9 and Comparative Examples 1 and 2) obtained in Examination 1 were evaluated according to the above-mentioned “Method of evaluating flavored oil and fat,” and the results are shown in Table 2 below. In this case, a commercially available sweet almond oil (manufactured by ease Co., Ltd.) was evaluated based on the same criteria as Reference Example 1, but the evaluation was 1 point because a specific flavor of roasted almonds was not recognized in the almond oil itself.

TABLE 2
Evaluation results of flavor of flavored oil

| | Reference | | | | | | | | | | Comparative | |
|---|---|---|---|---|---|---|---|---|---|---|---|---|
| | Example | Example | | | | | | | | | Example | |
| | 1 | 1 | 2 | 3 | 4 | 5 | 6 | 7 | 8 | 9 | 1 | 2 |
| Flavor | 1.0 | 3.5 | 3.0 | 3.5 | 3.0 | 3.0 | 4.0 | 3.0 | 3.5 | 4.5 | 2.0 | 1.0 |
| evaluation | | | | | | | | | | | | |

Examination 2 Preparation of Madeleine

TABLE 3
Formulation of madeleine

| | Reference | | | | | | | |
|---|---|---|---|---|---|---|---|---|
| | Example | Comparative Example | | Example | | | | |
| | 2 | 3 | 4 | 10 | 11 | 12 | 13 | 14 |
| Weak flour | 125.0 | 187.5 | 187.5 | 187.5 | 187.5 | 187.5 | 187.5 | 187.5 |
| Blanched ground almond | 125.0 | 62.5 | | | | | | |
| Oil and fat containing | | | 62.5 | | | | | |
| almond essence | | | | | | | | |
| Example 1 | | | | 62.5 | | | | |
| Example 2 | | | | | 62.5 | | | |
| Example 3 | | | | | | 62.5 | | |
| Example 8 | | | | | | | 62.5 | |
| Example 9 | | | | | | | | 62.5 |
| Granulated sugar | 250.0 | 250.0 | 250.0 | 250.0 | 250.0 | 250.0 | 250.0 | 250.0 |
| Egg white | 250.0 | 250.0 | 250.0 | 250.0 | 250.0 | 250.0 | 250.0 | 250.0 |
| Butter | 250.0 | 250.0 | 250.0 | 250.0 | 250.0 | 250.0 | 250.0 | 250.0 |
| Starch syrup | 25.0 | 25.0 | 25.0 | 25.0 | 25.0 | 25.0 | 25.0 | 25.0 |
| Baking powder | 2.5 | 2.5 | 2.5 | 2.5 | 2.5 | 2.5 | 2.5 | 2.5 |

125 parts of weak flour, 125 parts of blanched ground almonds (skinless ground almonds), 250 parts of granulated sugar, 250 parts of butter, 25 parts of starch syrup, and 2.5 parts of baking powder were mixed in each rate, and while stirring the mixture using a mixer, 250 parts of egg white warmed to around 25° C. was gradually added thereinto. Thereby, a madeleine dough was prepared. This kneaded dough was flowed into a madeleine mold over about 8 minutes, and the dough was baked in an oven under conditions of 230° C. and 15 minutes. Thereby, a madeleine of Reference Example 2 was prepared.

A madeleine of Comparative Example 3 was prepared in the same manner as in the reference example except that an amount of ground almonds was changed to 62.5 parts (half the amount of Reference Example 2), and an amount of weak flour was increased to 187.5 parts.

A madeleine of Comparative Example 4 was prepared in the same manner as in Comparative Example 3 except that ground almonds were replaced by an oil and fat containing almond essence. The oil and fat containing almond essence was a purified palm oil into which 0.2% by weight of a baking-resistant almond flavor had been added. This oil and fat was melted at about 50° C. and was gradually added after addition of an egg white liquid.

A madeleine of Example 10 was prepared in the same manner as in Comparative Example 3 except that ground almonds were replaced by the roasted almond-flavored oil and fat of Example 1.

A madeleine of Example 11 was prepared in the same manner as in Example 10 except that the roasted almond-flavored oil and fat of Example 1 was replaced with the roasted almond-flavored oil and fat of Example 2.

A madeleine of Example 12 was prepared in the same manner as in Example 10 except that the roasted almond-flavored oil and fat of Example 1 was replaced with the roasted almond-flavored oil and fat of Example 3.

A madeleine of Example 13 was prepared in the same manner as in Example 10 except that the roasted almond-flavored oil and fat of Example 1 was replaced with the roasted almond-flavored oil and fat of Example 8.

A madeleine of Example 14 was prepared in the same manner as in Example 10 except that the roasted almond-flavored oil and fat of Example 1 was replaced with the roasted almond-flavored oil and fat of Example 9.

“Method of Evaluating Flavor of Madeleine”

The same five people who were the panelists in the above-described “Method of evaluating flavored oil and fat” performed a sensory evaluation on the madeleine samples prepared with the formulations shown in Table 3 after one day and four days. They performed a flavor evaluation regarding the initial flavor and its persistence. Further

First, the flavor after one day of Reference Example 2 (in which ground almonds were used 100%) was evaluated as 3 points (standard). By comparing with this flavor, a decision was made by a consensus on scores of 1 to 5 in terms of whether imparting of a stronger almond-flavor was recognized and whether the flavor was preferred for madeleines. As a result of the flavor evaluation, 3 or higher points were regarded as a pass.

TABLE 4
Evaluation results of flavor of madeleine

| | | Reference | | | | | | | |
|---|---|---|---|---|---|---|---|---|---|
| | | Example | Comparative Example | | Example | | | | |
| | | 2 | 3 | 4 | 10 | 11 | 12 | 13 | 14 |
| Flavor | After | 3.0 | 2.0 | 2.0 | 3.0 | 3.0 | 3.0 | 3.0 | 4.0 |
| evaluation | one day | | | | | | | | |
| | After | 2.0 | 1.0 | 1.0 | 3.0 | 3.0 | 3.0 | 3.0 | 4.0 |
| | four days | | | | | | | | |

| | | | | | | | | |
|---|---|---|---|---|---|---|---|---|
| Amount of ground | 100 | 50 | 0 | 0 | 0 | 0 | 0 | 0 |
| almonds used (%) | | | | | | | | |

Regarding an amount of ground almonds used in the table, an amount of ground almonds used in each of the comparative examples and examples was calculated with an amount of ground almonds used in the reference example as 100%.

Examination 3 Preparation of Galette Dough

TABLE 5
Formulation of galette

| | | |
|---|---|---|
| Reference | Comparative | |
| Example | Example | Example |

| | 3 | 5 | 15 | 16 |
|---|---|---|---|---|
| Weak flour | 400.0 | 425.0 | 450.0 | 450.0 |
| Blanched ground | 100.0 | 50.0 | | |
| almond | | | | |
| Butter | 400.0 | 425.0 | 400.0 | 400.0 |
| Example 1 | | | 50.0 | |
| Example 9 | | | | 50.0 |
| Powdered sugar | 306.0 | 306.0 | 306.0 | 306.0 |
| Egg yolk | 72.0 | 72.0 | 72.0 | 72.0 |
| Table salt | 6.0 | 6.0 | 6.0 | 6.0 |
| Baking powder | 3.6 | 3.6 | 3.6 | 3.6 |

306 parts of powdered sugar, 6 parts of table salt, and 400 parts of butter were rubbed together with a mixer to be sufficiently formed into a paste. Thereafter, 72 parts of egg yolk was gradually flowed thereinto while being stirred. Finally, a powder obtained by mixing 400 parts of weak flour, 100 parts of blanched ground almonds (skinless ground almonds), and 3.6 parts of baking powder in each rate in advance was gradually added into the mixture. Thereby, a galette dough was prepared. This dough was cut into a 5.5-cm piece. The cut piece was put in a 6.0-cm cercle and baked in an oven under conditions of 155° C. for top heat and 135° C. for bottom heat for 28 minutes. Thereby, a galette of Reference Example 3 was prepared.

A galette of Comparative Example 5 was prepared in the same manner as in Reference Example 3 except that an amount of ground almonds was changed to 50 parts (half the amount of Reference Example 3), an amount of weak flour was increased to 425 parts, and an amount of butter was increased to 425 parts.

A galette of Example 15 was prepared in the same manner as in Reference Example 3 except that ground almonds were replaced by the roasted almond-flavored oil and fat of Example 1, an amount of weak flour was changed to 450 parts, and an amount of butter was changed to 400 parts.

A galette of Example 16 was prepared in the same manner as in Example 15 except that the roasted almond-flavored oil and fat of Example 1 was replaced with the roasted almond-flavored oil and fat of Example 9.

“Method of Evaluating Flavor of Galette”

The same five people who were the panelists in the above-described “Method of evaluating flavored oil and fat” performed a sensory evaluation on the galette samples prepared with the formulations shown in Table 3 after one day and four days. They performed a flavor evaluation regarding the initial flavor and its persistence. Further

First, the flavor after one day of Reference Example 3 (in which ground almonds were used 100%) was evaluated as 3 points (standard). By comparing with this flavor, a decision was made by a consensus on scores of 1 to 5 in terms of whether imparting of a stronger almond-flavor was recognized and whether the flavor was preferred for galettes. As a result of the flavor evaluation, 3 or higher points were regarded as a pass.

TABLE 6
Evaluation results of flavor of galette

| | | Reference | Comparative | | |
|---|---|---|---|---|---|
| | | Example | Example | Example | |
| | | 3 | 5 | 15 | 16 |
| Flavor evaluation | After one day | 3.0 | 2.0 | 3.0 | 4.0 |
| | After four days | 2.0 | 1.0 | 3.0 | 4.0 |

| | | | | |
|---|---|---|---|---|
| Amount of ground almonds used | 100 | 50 | 0 | 0 |
| (%) | | | | |

Conclusions

By adding an almond-derived raw material into an oil and fat and heating them, it is possible to produce a roasted almond-flavored oil and fat having deliciousness and longer flavor persistence while allowing reduction in amount of ground almonds used in western-style confectionery.

In addition, it was confirmed that a flavored oil and fat, which was prepared by using blanched ground almonds and replacing the inside of a reaction system with an inert gas, represented a preferred flavor which does not exist in the related art and is different from the ground almonds themselves, and its flavor stood out particularly when it is used for western-style confectionery.

1. A production method of a flavored oil and fat comprising:
reacting an oil and fat at 80° C. to 210° C. for 0.2 to 4 hours in the presence of 0.6% to 20% by mass of an almond-derived raw material with respect to the oil and removing solid contents thereafter.

2. The production method according to claim 1, wherein the almond-derived raw material is ground almonds.

3. The production method according to claim 1, wherein the reaction is carried out in a depressurization state.

4. The production method according to claim 1, wherein the reaction is carried out in an inert gas atmosphere.

5. The production method according to claim 4, wherein a temperature is raised by heating in the inert gas atmosphere.

6. A food product formed using a flavored oil and fat produced by the production method according to claim 1.

7. A western-style confectionery formed using a flavored oil and fat produced by the production method according to claim 1.

8. The production method according to claim 2, wherein the reaction is carried out in a depressurization state.

9. The production method according to claim 2, wherein the reaction is carried out in an inert gas atmosphere.

10. The production method according to claim 9, wherein a temperature is raised by heating in the inert gas atmosphere.

11. A food product formed using a flavored oil and fat produced by the production method according to claim 2.

12. A food product formed using a flavored oil and fat produced by the production method according to claim 3.

13. A food product formed using a flavored oil and fat produced by the production method according to claim 4.

14. A food product formed using a flavored oil and fat produced by the production method according to claim 5.

15. A western-style confectionery formed using a flavored oil and fat produced by the production method according to claim 2.

16. A western-style confectionery formed using a flavored oil and fat produced by the production method according to claim 3.

17. A western-style confectionery formed using a flavored oil and fat produced by the production method according to claim 4.

18. A western-style confectionery formed using a flavored oil and fat produced by the production method according to claim 5.
